(19) United States
(12) Patent Application Publication
(10) Pub. No.: US 2013/0101363 A1
(43) Pub. Date: Apr. 25, 2013

(54) CUTTING INSERT AND INDEXABLE MILLING TOOL

(71) Applicant: TUNGALOY CORPORATION, Iwaki-shi (JP)

(72) Inventor: Shirou YOSHIOKA, Iwaki-shi (JP)

(73) Assignee: TUNGALOY CORPORATION, Iwaki-shi (JP)

(21) Appl. No.: 13/715,231

(22) Filed: Dec. 14, 2012

Related U.S. Application Data
(63) Continuation-in-part of application No. PCT/JP2011/062657, filed on Jun. 2, 2011.

(30) Foreign Application Priority Data
Jun. 21, 2010 (JP) 2010-140511

(51) Int. Cl. B23C 5/20

(52) U.S. Cl. CPC B23C 5/207; B23C 5/205
USPC 407/42; 407/114

(57) ABSTRACT

A cutting insert is suitable for pocket machining. The cutting insert (10) includes a rake face (14); a flank (15); and a main cutting edge (11) formed in an intersecting portion between the rake face (14) and the flank (15) and extending in a direction intersecting a cutting direction of a milling tool. The main cutting edge includes at least one separating portion (12) not involved in cutting, in the middle of the main cutting edge (11) in a direction along the main cutting edge (11). The main cutting edge (11) is formed of at least two cutting edges (11a, 11b) separated by the separating portion (12), and when the cutting insert is attached to a tool body (1) of the cutting tool, cutting edge angles κ1 and κ2 of the cutting edges (11a,11b) are set within a range from 5° or more to 20° or less.

### CROSS-REFERENCE TO RELATED APPLICATIONS

This application is a Continuation-in-part of International Application No. PCT/JP2011/062657 filed Jun. 2, 2011 and published as WO 2011/162081A1, which claims the benefit of Japanese Patent Application No. 2010-140511, filed Jun. 21, 2010. The contents of the aforementioned applications are incorporated by reference herein in their entirety.

### BACKGROUND OF THE INVENTION

1. Field of the Invention

The present invention relates to a cutting insert and an indexable milling tool to which the cutting insert is attached.

2. Description of the Related Art

In prior-art pocket machining performed in manufacture of a molding die or the like, a milling tool capable of drilling might be used. In the pocket machining, steady discharge of produced chips from a machined recess (pocket) is one of the conditions for efficient machining, and air-blow is used for that purpose. In this discharging method, a high-pressure air is injected toward the machined recess so as to blow out the chips to the outside of the hole by its wind pressure.

Even if the air-blow is used, injection of air at such high pressure that can blow out the chips of any size is not possible, and generation of chips broken up as fine as possible is required for a milling tool for performing the pocket machining. As a method of breaking up the chips, Japanese Patent Laid-Open No. 2007-283482 discloses a cutting insert in which a plurality of nicks is formed in a flank so as to discontinue a cutting edge.

### SUMMARY OF THE INVENTION

However, the cutting insert having a nick as disclosed in Japanese Patent Laid-Open No. 2007-283482 cannot cut a portion where the nick is formed if the cutting insert is used singularly. Thus, a cutting insert having another shape for additionally cutting a portion which is not cut by the one cutting insert with a nick is further needed. Therefore, if the cutting insert having a nick is used, a plurality of types of inserts needs to be prepared all the time, which incurs an increase in a storage cost. Moreover, even if the inserts have different shapes, the difference is slight, and there was a chance of an attachment error of attaching an insert other than the type which should have been attached.

The present invention was made in order to solve the above-described problems and has an object to provide a cutting insert capable of breaking up chips with one type of insert and a milling tool to which the cutting insert can be attached.

That is, the cutting insert of the present invention is a cutting insert removably attachable to a tool body of a milling tool, including :
a rake face;
a flank; and
a cutting edge formed at an intersecting portion between the rake face and the flank, wherein
a main cutting edge of the cutting edge comprises at least two separated small cutting edges;
two adjacent small cutting edges among the at least two small cutting edges are connected to a separating portion, respectively;
the separating portion is formed between the two adjacent small cutting edges on the intersecting portion between the rake face and the flank; and
when seen from the front of the rake face, a connection portion between one of the small cutting edges located on the rear side with respect to the separating portion in a feeding direction and the separating portion is formed closer to the center of the cutting insert than a virtual straight line extending through the other small cutting edge located on the front side with respect to the separating portion in the feeding direction to the side of the one small cutting edge located on the rear side in the feeding direction.

Preferably, the cutting insert has a cutting edge angle of small cutting edge located on the rear side in a feeding direction in two adjacent small cutting edges interposing a single separating portion therebetween is smaller than a cutting edge angle of the other small cutting edge located on the front side in the feeding direction.

Preferably, in the cutting insert, when a cutting edge angle of one small cutting edge is set to 5° or more and 20° or less, cutting edge angles of all the other small cutting edges are 5° or more and 20° or less.

Preferably, the separating portion is formed in a substantially linear in the cutting insert.

To the indexable milling tool of the present invention, the cutting insert of any of the present inventions described above is able to be removably attached.

In the cutting edge of the cutting insert of the present invention, the main cutting edge is separated into a plurality of portions, but since those cutting regions partially overlap each other, broken-up chips can be produced and moreover, machining with one type of a cutting insert is possible. Thus, a cost and a labor required for management of the cutting insert of the present invention become extremely smaller than before.

Moreover, when the cutting insert of the present invention is to be attached, it is not necessary to consider at which spot in the tool body which insert is attached, extremely smooth replacement/attachment works become possible.

In the main cutting edge of the cutting insert of the present invention, at least one separating portion not involved in cutting and connecting two separated small cutting edges is provided in the middle of the main cutting edge in a direction along the main cutting edge. Chips produced from each of the small cutting edges separated from each other are small in length in a direction along the main cutting edge and in volume, and such compact and light-weighted chips are easily discharged from the pocket by air-blow in pocket machining, and a defect in the cutting edge caused by biting of the chips or damage on a worked surface are suppressed.

In the indexable milling tool according to the present invention, since the cutting insert of the present invention is used, no labor is required such as attachment of inserts of different types depending on an insert attachment seat. Thus, a mechanical work is facilitated, and time for replacement work is made shorter than before.

Moreover, since the chips produced by the indexable milling tool according to the present invention are broken up and the thickness is small, if the indexable milling tool of the present invention is used in pocket machining, various problems caused by non-discharge of the chips from a machined hole such as biting of the chips and the like become difficult to occur.

Further features of the present invention will become apparent from the following description of exemplary embodiments (with reference to the attached drawings).

### BRIEF DESCRIPTION OF THE DRAWINGS

FIG. 1 is a front view of a cutting insert according to an embodiment of the present invention;

FIG. 2 is a right side view of the cutting insert illustrated in FIG. 1;

FIG. 3 is a plan view of the cutting insert illustrated in FIG. 1;

FIG. 4 is a view in the direction of the arrow X in FIG. 1;

FIG. 5 is an enlarged view of a main cutting edge of the cutting insert in FIG. 1;

FIG. 6 is a front view of an end mill according to an embodiment of the present invention;

FIG. 7 is a right side view of an essential part of the end mill illustrated in FIG. 6; and

FIG. 8 is a plan view of the essential part of the end mill illustrated in FIG. 6.

### DETAILED DESCRIPTION

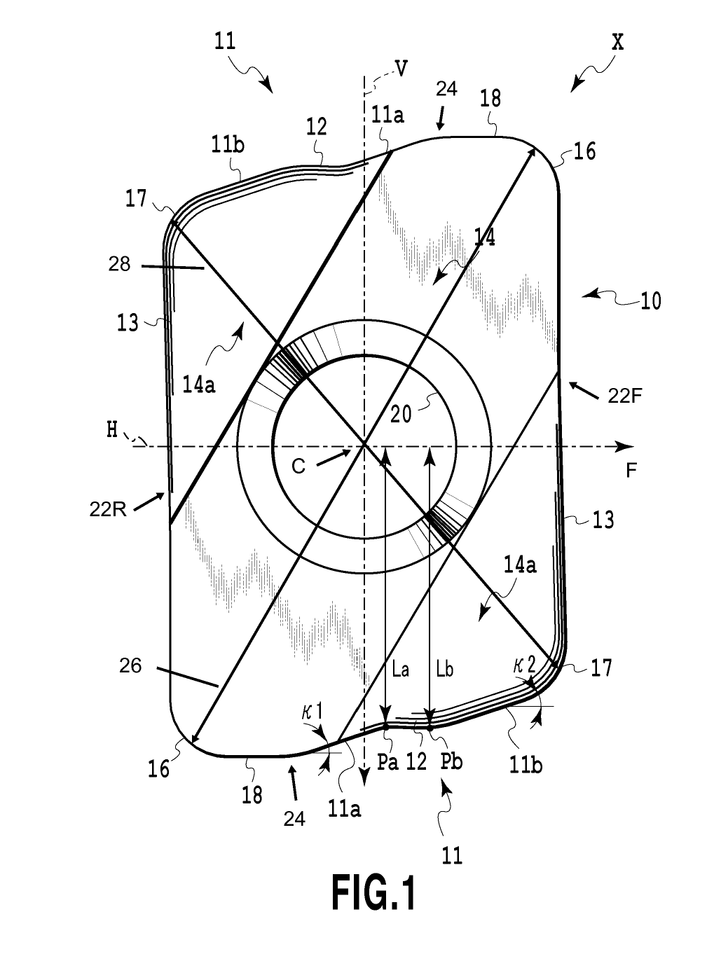

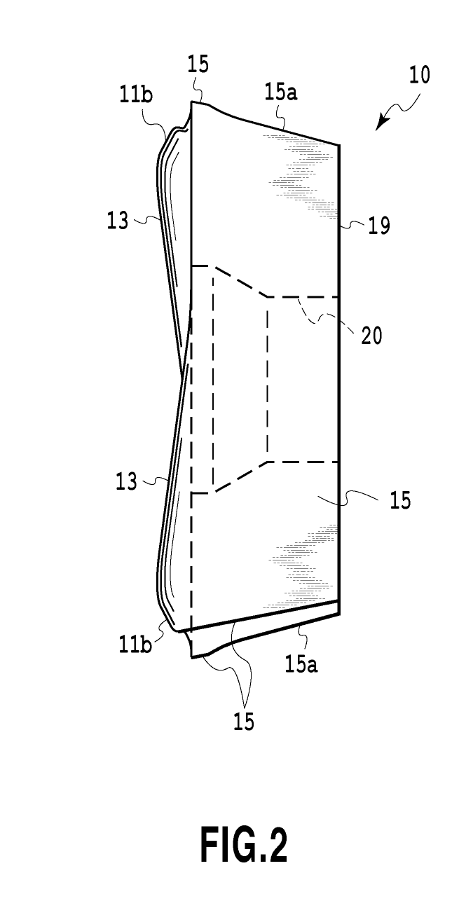

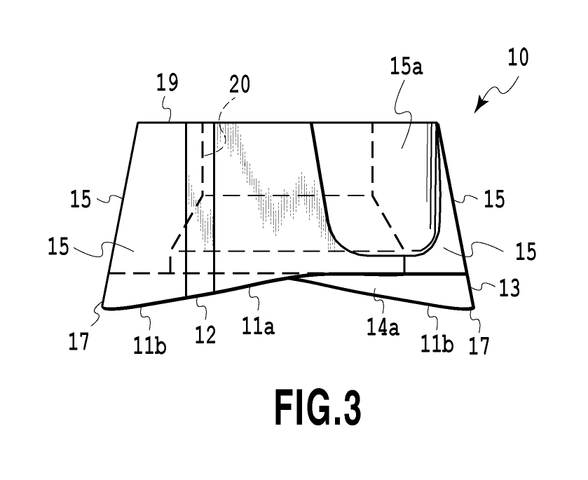

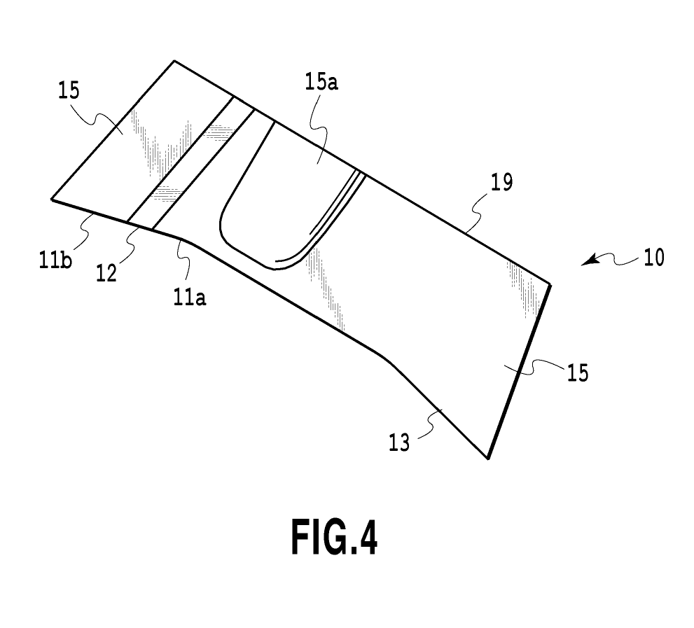

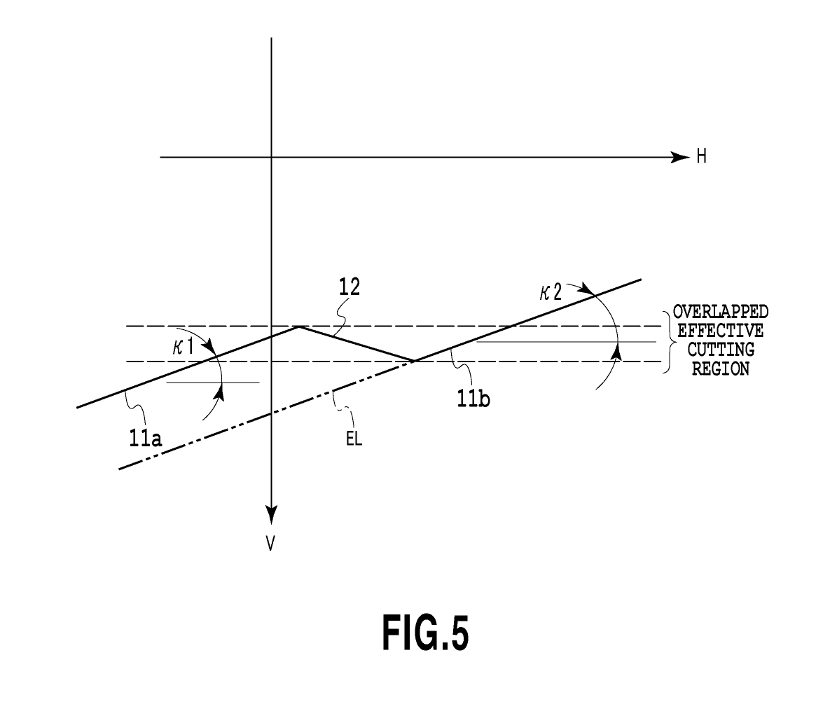

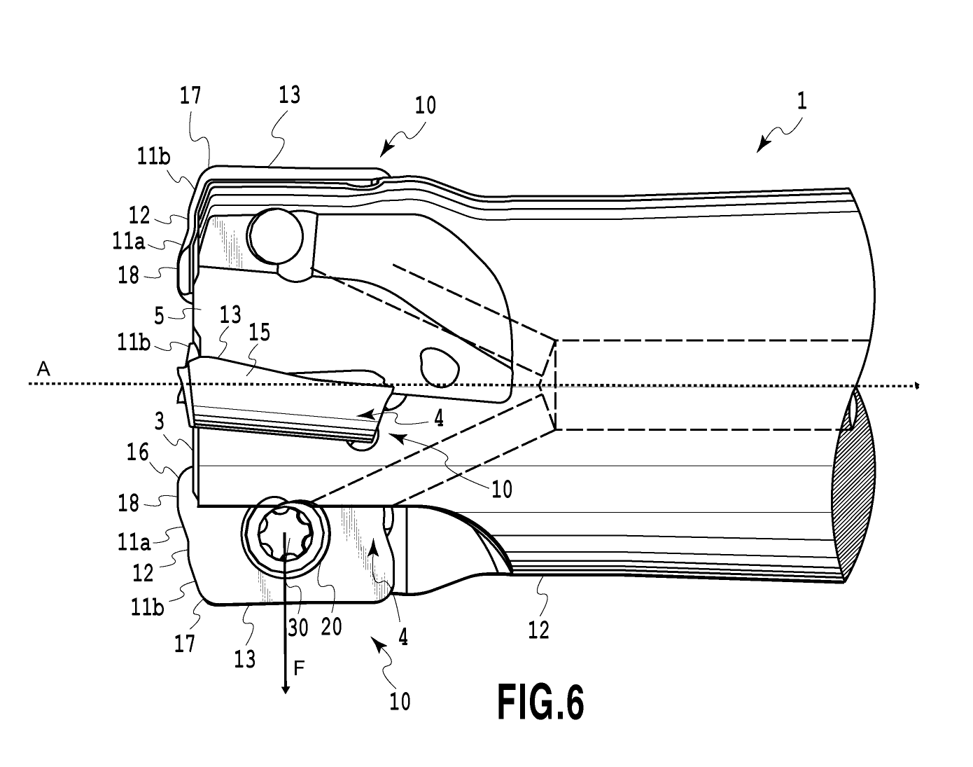

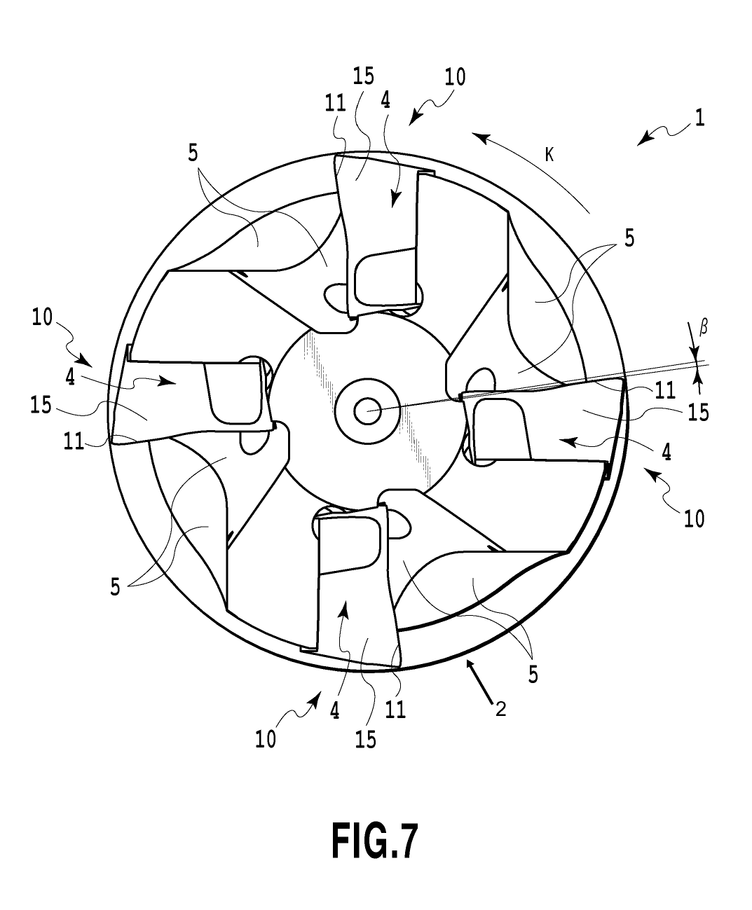

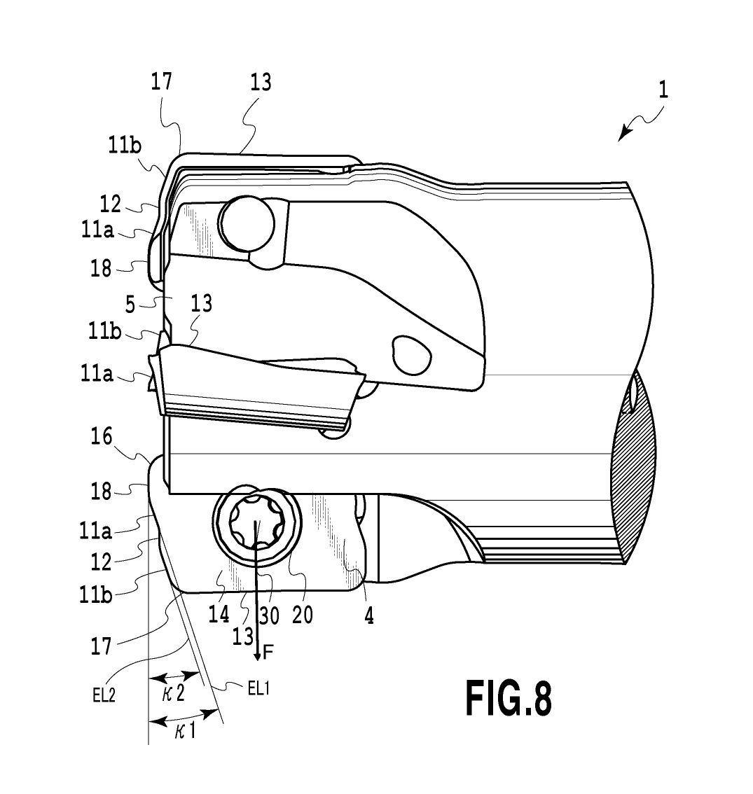

An end mill according to an embodiment of the present invention will be described below by referring to the attached drawings. FIG. 1 is a front view of a cutting insert used in the end mill. FIGS. 2 and 3 are a right side view and a plan view of the cutting insert illustrated in FIG. 1, respectively. FIG. 4 is a view in the direction of the arrow X in FIG. 1. FIG. 5 is an enlarged view of a main cutting edge of the cutting insert in FIG. 1. FIG. 6 is a front view of the end mill when seen from an axial direction. FIGS. 7 and 8 are a right side view and a plan view of an essential part of the end mill illustrated in FIG. 5, respectively.

A cutting insert 10 according to this embodiment has a substantially parallelogram plate shape as illustrated in FIG. 1, in which in opposing upper and lower faces, a rake face 14 is formed on the upper face and a seat face 19 is formed on the lower face, a flank 15 is formed on a side face extending between the opposing upper and lower faces, and a cutting edge is formed at an intersecting portion between the rake face 14 and the flank 15. At the center in the opposing upper and lower faces, a mounting hole 20 is formed penetrating the upper and lower faces. Due to its different upper and lower faces, cutting insert 10 is a non-reversible, single-sided cutting insert. As seen in the front view of FIG. 1, the rake face 14 has two long sides 22F, 22R, two short sides 24, a long diagonal 26 and a short diagonal 28 which intersect at an insert center C. The cutting insert 10 has a feeding direction F extending along the center feed axis H, which is perpendicular to the long sides 22F, 22R and passes through the insert center C. The feeding direction F defines a front-to-rear direction of the insert, as indicated by the front long side 22F (right side of insert in FIG. 1) and the rear long side 22R (left side of insert in FIG. 1).

The cutting insert 10 is a so-called positive type insert in which each of the flanks 15 is inclined inward as it gets closer to the lower face from the cutting edge and at least the cutting edge is made of a hard material such as cemented carbide, cermet and ceramic, ultra high pressure sintered compact such as diamond and CBN or any of the above-described material coated with metal compounds containing Ti, alumina or the like.

The cutting edge formed on a pair of short sides of the rake face 14 is provided with an acute angle corner 16, a wiper cutting edge 18 continuing to the acute angle corner 16, a main cutting edge 11 continuing to the wiper cutting edge 18, and an obtuse angle corner 17 continuing to the main cutting edge 11, and the wiper cutting edge 18 extends linearly in a direction substantially in parallel with the center feed axis H. The center feed axis H is an axis in parallel with a feeding direction in this embodiment, and the right side is the feeding direction in FIG. 1. A length of the wiper cutting edge 18 is formed so as to be equal to or slightly larger than a maximum feed rate assumed in a cutting tool to which the cutting insert 10 is attached. The wiper cutting edge 18 may have an arc shape.

The main cutting edge 11 is formed on the intersecting portion between the rake face 14 and the flank 15. This main cutting edge 11 is separated into two short small cutting edges by a separating portion 12 formed on the intersecting portion between the rake face 14 and the flank 15 similarly to the main cutting edge 11. Then, in the explanation below, the small cutting edge on the rear side with respect to the separating portion 12 in the feeding direction will be referred to as a first cutting edge 11a, and the small cutting edge on the front side with respect to the separating portion 12 in the feeding direction will be referred to as a second cutting edge 11b.

A peripheral cutting edge 13 is formed on each of a pair of long sides of the rake face 14, and the cutting insert 10 is attached so that the peripheral cutting edge 13 is in parallel with the central axis of the rotating tool body or a back taper is created.

A seat face 19 formed on the lower face of the cutting insert 10, a side face extending from the peripheral cutting edge 13 (flank 15), and a side face extending from the wiper cutting edge 18 (flank 15a) function as contact faces in contact with the seat face and a peripheral wall of an insert seat provided in the rotating tool body.

As illustrated in FIG. 1, when the rake face 14 is seen on the front, the first cutting edge 11a and the second cutting edge 11b are formed linearly. However, the first cutting edge 11a and the second cutting edge 11b may be curved in an arc shape. A first cutting edge angle κ1 of the first cutting edge 11a is set within a range of 5° or more and 20° or less, and a second cutting edge angle κ2 of the second cutting edge 11b is also set within a range of 5° or more and 20° or less. In other words, it is designed such that, when the cutting insert 10 is attached to the rotating tool body so that the first cutting edge angle κ1 of the first cutting edge 11a is 5° or more and 20° or less, the second cutting edge angle κ2 of the second cutting edge 11b is also within a range of 5° or more and 20° or less at the same time. If the cutting edge angles are set within the above-described range, a chip thickness becomes small and thus, cutting resistance applied to a cutting boundary portion is suppressed small even in high-feed machining with a large feed rate, and occurrence of chipping, defect and the like at that portion is suppressed.

In FIG. 1, assuming that the cutting insert 10 of this embodiment is fed in the feeding direction along the center feed axis Has described above and used so as to cut in a the direction of the V-axis perpendicular to the center feed axis H, each of the cutting edge angles κ1 and κ2 is illustrated. In this case, the cutting edge angle κ1 is defined by an angle formed by the first cutting edge 11a and an axis line in parallel with the center feed axis H, while the second cutting edge angle κ2 is defined by an angle formed by the second cutting edge 11b and the axis line in parallel with the center feed axis H. Each of the cutting edge angles κ1 and κ2 is set separately and independently without being affected by a set value of one of the cutting edge angles. Therefore, the first cutting edge angle κ1 and the second cutting edge angle κ2 might be different from each other or these two values might be the same. However, if the magnitude of the second cutting edge angle κ2 is larger than that of the first cutting edge angle κ1, the maximum value of the depth of cut when being considered as the insert as a whole increases, and efficient machining becomes possible. If the first cutting edge 11a or the second cutting edge 11b has an arc shape, each of the small cutting edges is designed so that the maximum value of the cutting edge angle is within a range of 5° or more and 20° or less.

The linear first cutting edge 11a of this embodiment is formed so that a first distance (Lb) from a first connection portion (Pb) located between the separating portion 12 and the second cutting edge 11b to the center feed axis H is longer than a second distance (La) from a second connection portion (Pa) located between the separating portion 12 and the first cutting edge 11a to the center feed axis H. In other words, the second connection portion (Pa) located between the first cutting edge 11a and the separating portion 12 is formed closer to the center of the cutting insert 10 than a virtual straight line (EL) obtained by extending the second cutting edge 11b toward the first cutting edge 11a (See FIG. 5).

Thus, the separating portion 12 is formed closer to the rear side in the V-axis direction than an axis line passing through the first connection portion Pb and in parallel with the center feed axis H. The separating portion 12 is not brought into contact with a workpiece even if the second cutting edge 11b is performing cutting and so is not involved in cutting. Moreover, if the separating portion 12 as above is formed, an overlapped effective cutting region at the same time is produced between the effective cutting region of the first cutting edge 11a and the effective cutting region of the second cutting edge 11b. As a result, by using the single cutting insert 10 of this embodiment or just a plurality of the cutting inserts 10 of this embodiment, a portion not cut is not formed in the workpiece. Since the cutting insert 10 of this embodiment is a positive insert, a side face extending from the separating portion 12 to the lower face is also formed of an inclined face inclined inward of the cutting insert 10 as it goes to the lower face.

The cutting insert 10 of this embodiment does not form a portion not cut on the machined face as described above. Therefore, cutting by using only the cutting insert 10 of this embodiment is possible, and a storage cost is reduced. Moreover, if the cutting insert 10 of this embodiment is used in a milling tool using a plurality of cutting inserts, since labor to consider the type of the cutting insert for each attachment spot is not necessary, efficient cutting edge replacement can be realized.

The separating portion 12, the first cutting edge 11a, and the second cutting edge 11b are not limited to the above-described embodiment. That is, a main technical idea of the cutting insert 10 of the present invention is that the main cutting edge is separated into two or more short small cutting edges by providing a portion not involved in the cutting on the main cutting edge and an effective cutting region of each separated small cutting edge is partially overlapped with each other and thus, the cutting insert having the main cutting edge in a shape realizing the above is within a technical scope of the present invention.

Thus, the separating portion is not limited to a linear shape as in the above-described embodiment but may have a curved shape, for example. In that case, too, if the connection portion between the small cutting edge and the separating portion located on the rear side with respect to the separating portion in the feeding direction is formed closer to the center of the cutting insert than a virtual extension line obtained by extending the other small cutting edge on the front side in the feeding direction toward the small cutting edge located on the rear side in the feeding direction, the cutting edge angle can be set such that the separating portion is no longer involved in the cutting and the effective cutting regions of the two small cutting edges are partially overlapped. If the separating portion is a curved line, the curved line may be concavely curved in a recess shape toward the center of the cutting insert or may be convexly curved in a projection shape toward the outside of the cutting insert.

If the connection portion between the small cutting edge on the rear side in the feeding direction and the separating portion is located closer to the outside of the cutting insert than the virtual extension line of the small cutting edge located on the front side in the feeding direction, whatever cutting edge angle is set, the separating portion is also involved in the cutting. The term “front side in the feeding direction” refers to a place on the same side as the feeding direction than a certain position when the certain position is based, and the term “rear side in the feeding direction” refers to a place on the side in the direction opposite to the feeding direction with respect to the certain position when the certain position is based.

As another form of the cutting insert of the present invention, though the first cutting edge 11a and the separating portion 12 cross each other at an obtuse angle in this embodiment, they may instead cross each other at an acute angle. Similarly, the separating portion 12 and the second cutting edge 11b may cross each other at an acute angle or may cross each other at an obtuse angle.

As another form of the cutting insert of the present invention, one of the small cutting edges with respect to the separating portion can be linear and the other small cutting edge can have an arc shape (not shown). As still another form, the main cutting edge can have two or more separating portions and three or more small cutting edges (not shown). In this case, a relationship between a given separating portion and the small cutting edges connected to the both ends thereof needs to be such that, as described above, the connection portion between the small cutting edge located on the rear side with respect to the given separating portion in the feeding direction and the given separating portion is formed closer to the center of the cutting insert than the virtual extension line obtained by extending the other small cutting edge on the front side in the feeding direction toward the small cutting edge located on the rear side in the feeding direction. As another form of the cutting insert of the present invention, a triangle, a polygonal plate shape such as a pentagon, or a negative insert can be used as replacement.

Subsequently, the milling tool of the present invention will be described by using an end mill which is one embodiment thereof. As illustrated in FIGS. 6 to 8, the cutting insert 10 of the above-described embodiment is removably attached to an insert seat 4 provided at a leading end peripheral portion of the tool body 1 having a substantially cylindrical shape by a clamp screw 30 inserted into the mounting hole 20. On the front side in a tool rotating direction K of the insert seat 4, an insert pocket 5 formed by cutting off an outer peripheral face 2 of the tool body is provided adjacent to the insert seat 4, and in front of the rake face 14 of the cutting insert 10 attached to the insert seat 4, a sufficient space for accommodating chips is formed.

The cutting insert 10 is attached to the tool body 1 such that, as known from FIGS. 7 and 8, the obtuse angle corner 17, the second cutting edge 11b, and the first cutting edge 11a protrude from the leading edge face 3 of the tool body 1 and also, the outer peripheral cutting edge 13 protrudes from the outer peripheral face 2 of the tool body 1. Here, the cutting insert 10 is attached so that an end portion on the side located on the base end side of the tool body 1 is somewhat tilted toward the center of the tool body 1. As a result, the cutting edge angles κ1 and κ2 are within a range of 5° or more and 20° or less, and the outer peripheral cutting edge 13 becomes parallel with the central axis A of the tool body 1 or has a back taper.

In this end mill, as illustrated in FIGS. 7 and 8, end portions of the first cutting edge 11a and the second cutting edge 11b connected to each end portion of the separating portion 12 are separated from each other in the radial direction of the tool body 1. _Also, the second cutting edge 11b is located closer to the leading end of the tool body 1 than a first extension line EL1 of the first cutting edge 11a which is substantially in parallel with the extension line EL2 of the second cutting edge, both extension lines EL1, EL2 extending in a generally radially outward direction away from the leading end face 3. Moreover, the second connection portion (corresponding to Pb in FIG. 1) between the separating portion 12 and the second cutting edge 11b portion is located closer to the leading end of the tool body 1 than the first connection portion (corresponding to Pa in FIG. 1) between the separating portion 12 and the first cutting edge 11a.

Since the second connection portion Pb between the separating portion 12 and the second cutting edge 11b protrudes toward the leading end of the tool body 1 further than the first connection portion Pa between the separating portion 12 and the first cutting edge 11a, the entire separating portion 12 is recessed closer to the rear end of the tool body 1 than at least a leading portion of the second cutting edge 11b. Thus, the separating portion 12 becomes a portion not brought into contact with the workpiece at all and not involved in the cutting during machining. It is needless to say that the side face extending from the separating portion 12 to the lower face is also formed of an inclined face inclined inward of this cutting insert as it goes to the lower face so as not to touch the workpiece.

According to the cutting insert and the end mill of this embodiment, one separating portion 12 not involved in the cutting is formed in the middle of the main cutting edge 11, and as a result, the main cutting edge 11 is separated into two parts, that is, the first cutting edge 11a and the second cutting edge 11b, and thus, each cutting edge produces a chip which is short and small in the volume and has a width according to a cutting edge length thereof. In pocket machining of a molding die, such compact and light-weight chips are easily discharged from the pocket by air-blow and thus, a defect in the main cutting edge 11, the outer peripheral cutting edge 13 and the like caused by biting of the chips can be suppressed.

Since the first cutting edge angle κ1 of the first cutting edge 11a and the second cutting edge angle κ2 of the second cutting edge 11b are set within a range of relatively small values, that is, a range of 5° or more and 20° or less, substantial chip thicknesses of the first cutting edge 11a and the second cutting edge 11b become small, and a load during the cutting applied to the entire cutting edges is reduced. As a result, damage on the first cutting edge 11a or the second cutting edge 11b or particularly damage on the cutting boundary portion is suppressed, and a life of the entire cutting edge is improved.

In a cutting tool having a small cutting edge angle of the main cutting edge, a contact length between the main cutting edge and the workpiece is long in general and a width of the chip is large. However, in the cutting insert and the end mill of this embodiment, since the main cutting edge 11 is split into the first cutting edge 11a and the second cutting edge 11b, the width of the chip produced by the respective cutting edges becomes shorter than the length of the main cutting edge 11. On the other hand, since the first cutting edge angle κ1 of the first cutting edge 11a and the second cutting edge angle κ2 of the second cutting edge 11b are set to small values, respectively, the thicknesses of the chips produced by the first cutting edge 11a and the second cutting edge 11b become small. As known from the above, since the separating portion 12 is formed on the main cutting edge 11, the cutting insert 10 and the end mill of this embodiment can generate a chip which is small in width and thickness. The chip which is small in width and thickness is formed into a coil or spring shape which is compact, light-weight, and elastically deformed easily and so is easily discharged. Thus, an effect of suppressing defect on the cutting edge caused by biting of the chips becomes extremely high.

Since the respective parts of the first cutting edge 11a and the second cutting edge 11b are included in a region between a line in parallel with the center feed axis H passing through the first connection portion Pa of the first cutting edge 11a and a line in parallel with the center feed axis H passing through the second connection portion Pb of the second cutting edge 11b (See FIG. 5), an effective cutting region of the first cutting edge 11a and an effective cutting region of the second cutting edge 11b continue without disconnection. Thus, an uncut portion is not produced on the workpiece.

The rake face 14 of the cutting insert 10 according to this embodiment has a leading end of the obtuse angle corner 17 at the highest level in the thickness direction of the cutting insert 10, and as it separates from the obtuse angle corner 17, the level gradually lowers in the thickness direction of the cutting insert 10 (see FIG. 3). An inclined face 14a formed on such rake face 14 has a substantially triangular shape having the obtuse angle corner 17 as one apex when seen from a direction opposite to the rake face 14 (see FIGS. 1 and 3), and rake angles of the first cutting edge 11a, the second cutting edge 11b, and the outer peripheral cutting edge 13 continuing this inclined face 14a are increased thereby.

The two raised obtuse angle corners 17 are arranged at opposite ends of the short diagonal 28 while the lowered acute angle corners 16 are arranged at opposite ends of the long diagonal 26, with an inclined face 14a, being associated with each raised obtuse angle corner 17. The peripheral cutting edges 13 extend along the long sides 22F, 22R, each peripheral cutting edge 13 extending from one of the raised obtuse angle corners 17 towards an adjacent lowered acute angle corner 16. Meanwhile, the main cutting edges 11 extend along the short sides 24, each main cutting edge 11 extending from one of the raised obtuse angle corners 17 towards an adjacent lowered acute corner 16. Each main cutting edge 11 comprises separated first and second small cutting edges 11a, 11b, respectively, the second small cutting edge 11b being closer to the raised obtuse angle corner 17 than the first small cutting edge 11a. The non-cutting separation portion 12 formed between the first and second small cutting edges 11a, 11b on an intersecting portion between the rake face 14 and the flank face 15. In the front view of the rake face 14, a first connection portion Pa between the first small cutting edge 11a and the separating portion 12 is formed closer to a center of the insert—either or both the center feed axis H and the insert center C—than a virtual straight line extending through the second small cutting edge in a direction of the first small cutting edge 11a.

In the end mill attached with the cutting insert 10 with increased rake angles, a radial direction rake angle β of the first cutting edge 11a and the second cutting edge 11b mainly performing cutting increases. With the increase of the radial direction rake angle β, the cutting resistance is reduced, and stable machining with less tool rattling is realized in the pocket machining. The radial direction rake angle β is preferably a positive value rather than a negative value. If the radial direction rake angle β is positive, cutting resistance decreases and a direction of the cutting resistance is directed toward the center of the tool body 1. As a result, defect of the cutting edge is prevented. If the radial direction rake angle β is positive, an outflow direction of the chips produced by the first cutting edge 11a and the second cutting edge 11b is also directed toward the center of the tool body 1. Then, in wall face machining in which cutting is performed by leaving the wall face on the outer periphery side of the tool body 1 or particularly the wall face machining in pocket machining, the chips are prevented from being bitten in a gap between the wall face and the outer peripheral face 2 of the tool body. As a result, adhesion of the chips to the wall face is suppressed, and a quality of appearance of the wall face is improved.

Since the peripheral cutting edge 13 is arranged in parallel with the central axis A of the tool body 1 as in the end mill of this embodiment, the wall face of the workpiece is finished with high accuracy. However, if a contact length between the peripheral cutting edge 13 and the wall face becomes large, the increase in the cutting resistance might incur rattling of the tool, and thus, in order to prevent this, it may be so configured that the long side of the rake face 14 of the cutting insert 10 is inclined inward from the peripheral cutting edge from the middle thereof to the acute angle corner 16 or is recessed so that a back taper is provided arbitrarily.

The present invention has been described in the above-described embodiment and its variation and the like with some degree of specificity, but the present invention is not limited to them. For example, an end mill is used as an embodiment of a milling tool in the above description, but the milling tool of the present invention can be also applied to a milling tool other than the end mill such as a front milling cutter, a side cutter and the like. It should be understood that the present invention is capable of various modifications and changes without departing from the spirit or scope of the invention described in claims. That is, the prevent invention includes any variations, applications, and equivalents contained in the idea of the present invention specified by the claims.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A cutting insert removably attachable to a tool body of a milling tool and having a feeding direction, comprising:
a rake face;
a flank; and
a cutting edge formed at an intersecting portion between the rake face and the flank, wherein
a main cutting edge of the cutting edge comprises at least two separated small cutting edges;
adjacent first and second small cutting edges among the at least two small cutting edges are connected to a separating portion;
the separating portion is formed between the adjacent first and second small cutting edges on the intersecting portion between the rake face and the flank, the first small cutting edge being located on a rear side of the separating portion with respect to the feeding direction, and the second small cutting edge being located on a front side of the separating portion with respect to he feeding direction; and
when seen from the front of the rake face, a connection portion between the first small cutting edge and the separating portion is formed closer to a center of the cutting insert than a virtual straight line extending through the second small cutting edge in a direction towards the first small cutting edge.

2. The cutting insert according to claim 1, wherein
a first cutting edge angle of the first small cutting edge is smaller than a second cutting edge angle of the second small cutting edge.

3. The cutting insert according to claim 1, wherein
the cutting edge angles of all small cutting edges are set to 5° or more and 20° or less.

4. The cutting insert according to claim 1, wherein the separating portion is formed in a substantially linear shape.

5. An indexable milling tool, to which the cutting insert according to claim 1 is removably attached.

6. A non-reversible, single-sided cutting insert comprising:
a rake face having two long sides, two short sides, a long diagonal and a short diagonal intersecting at an insert center, two raised obtuse angle corners arranged at opposite ends of the short diagonal, two lowered acute angle corners arranged at opposite ends of the long diagonal, and an inclined face associated with each raised obtuse angle corner;
a feeding direction extending along a center feed axis H perpendicular to the long sides and passing through the insert center;
a flank face;
peripheral cutting edges extending along the long sides, each peripheral cutting edge extending from one of the raised obtuse angle corners towards an adjacent lowered acute angle corner;
main cutting edges extending along the short sides, each main cutting edge extending from one of the raised obtuse angle corners towards an adjacent lowered acute corner;
each main cutting edge comprising separated first and second small cutting edges, the second small cutting edge being closer to the raised obtuse angle corner than the first small cutting edge;
a non-cutting separation portion formed between the first and second small cutting edges on an intersecting portion between the rake face and the flank face;
in a front view of the rake face, a first connection portion between the first small cutting edge and the non-cutting separating portion is formed closer to at least one of the insert center and the center feed axis, than a virtual straight line extending through the second small cutting edge in a direction of the first small cutting edge.

7. The cutting insert according to claim 6, wherein
a first cutting edge angle of the first small cutting edge is smaller than a second cutting edge angle of the second small cutting edge.

8. The cutting insert according to claim 6, wherein
the first cutting edge angle and the second cutting edge angle are both set to 5° or more and 20° or less.

9. The cutting insert according to claim 6, wherein the separating portion is formed in a substantially linear shape.

10. An indexable milling tool, to which the cutting insert according to claim 6 is removably attached.
